(19) United States
(12) Patent Application Publication
(10) Pub. No.: US 2026/0050605 A1
(43) Pub. Date: Feb. 19, 2026

(54) VERSATILE DATA VIRTUALIZATION DRIVER

(71) Applicant: Cloud Software Group, Inc., Fort Lauderdale, FL (US)

(72) Inventor: Panagiotis Reveliotis, San Diego, CA (US)

(21) Appl. No.: 18/806,784

(22) Filed: Aug. 16, 2024

(51) Int. Cl. G06F 16/248; G06F 16/2453

(52) U.S. Cl. CPC G06F 16/248; G06F 16/24539

(57) ABSTRACT

Methods and systems for data virtualization are described. A computing system may transmit, by a client device and to a data virtualization server, a data virtualization query directed to a data source. The computing platform may receive, by the client device and from the data virtualization server, driver provision information comprising data source connection information for the data source and a native version of the data virtualization query. The computing platform may provision, at the client device and using the driver provision information, a native data source driver corresponding to the data source. The client device may transmit, to the data source and using the provisioned native source driver, the native version of the data virtualization query. The client device may receive, from the data source, data source results, and may display the data source results.

### FIELD

Aspects described herein generally relate to computer networking, remote computer access, virtualization, enterprise data management, and hardware and software related thereto. More specifically, one or more aspects described herein include a versatile data virtualization driver for efficient query processing.

### BACKGROUND

In some instances, client data processing devices may submit queries requesting data stored across a plurality of different data storage systems (e.g., databases, providers, systems, or the like). In some instances, to do so, virtualization servers may be used to process such queries. For example, client data processing devices may submit queries to backend data sources, which may be routed through data virtualization servers. The backend data sources may then identify a query result, and route the result to the client data processing device back through the virtualization server. This may result in performance overhead incurred by such data virtualization servers due to the significant volume of data being retrieved in response to such requests. Such overhead may create processing delays and/or inefficiencies in query processing. As a result, it may be important to provide a more efficient solution for such processing.

### SUMMARY

The following presents a simplified summary of various aspects described herein. This summary is not an extensive overview, and is not intended to identify required or critical elements or to delineate the scope of the claims. The following summary merely presents some concepts in a simplified form as an introductory prelude to the more detailed description provided below.

To overcome limitations in the prior art described above, and to overcome other limitations that will be apparent upon reading and understanding the present specification, aspects described herein are directed towards a versatile data virtualization driver for efficient query processing.

In one or more instances, a computing system, comprising a memory, one or more processors, and a communication interface may transmit, to a virtualization server, a data virtualization query directed to a data source. The computing system may receive, from the virtualization server, driver provision information comprising data source connection information for the data source and a native version of the data virtualization query. The computing system may provision, using the driver provision information, a data virtualization driver corresponding to the data source, wherein the data virtualization driver is configured to bypass the virtualization server for direct data retrieval from the data source. The computing system may transmit, to the data source and using the data virtualization driver, the native version of the data virtualization query. The computing system may receive, from the data source, data source results. The computing system may display the data source results.

In one or more instances, prior to transmitting the data virtualization query, the computing system (or another computing system) may transmit, to the virtualization server, connection information for the data source, wherein the connection information is used to introspect the data source. In one or more instances, prior to transmitting the data virtualization query, the computing system (or another computing system) may define a plurality of data views, wherein the data virtualization query is expressed in terms of the plurality of data views.

In one or more examples, the virtualization server may be further configured to: identify a data quantity requested by the data virtualization query, and compare the data quantity to a data volume threshold. In one or more examples, the virtualization server may be further configured to: send, based on identifying that the data quantity meets or exceeds the data volume threshold, the driver provision information.

In one or more instances, the virtualization server may be further configured to, based on identifying that the data quantity is less than the data volume threshold: transmit the native query to the data source, receive, from the data source, the data source results, and transmit, to the client device, the data source results. In one or more instances, the data virtualization query may be a query for a single data source of the data source.

In one or more examples, the computing system may cache, using the data virtualization driver, the native version of the data virtualization query. In one or more examples, the caching may be based on predicted queries to be sent from the client device for a particular application.

In one or more instances, the data virtualization driver may be specific to an application at the client device. In one or more instances, the driver provision information may further include provision partition clauses defining logical breakpoints used to split the data source result into a plurality of sub-results.

These and additional aspects will be appreciated with the benefit of the disclosures discussed in further detail below.

### BRIEF DESCRIPTION OF THE DRAWINGS

A more complete understanding of aspects described herein and the advantages thereof may be acquired by referring to the following description in consideration of the accompanying drawings, in which like reference numbers indicate like features, and wherein:

FIG. 1 depicts an illustrative computer system architecture that may be used in accordance with one or more illustrative aspects described herein.

FIG. 2 depicts an illustrative remote-access system architecture that may be used in accordance with one or more illustrative aspects described herein.

FIGS. 3A-3B depict an illustrative computing environment for configuring and implementing a versatile data virtualization driver in accordance with one or more illustrative aspects described herein.

FIGS. 4A-4B depict an illustrative event sequence for configuring and implementing a versatile data virtualization driver in accordance with one or more illustrative aspects described herein.

FIGS. 5-6 depict illustrative methods for configuring and implementing a versatile data virtualization driver in accordance with one or more illustrative aspects described herein.

### DETAILED DESCRIPTION

In the following description of the various embodiments, reference is made to the accompanying drawings identified above and which form a part hereof, and in which is shown by way of illustration various embodiments in which aspects described herein may be practiced. It is to be understood that other embodiments may be utilized and structural and functional modifications may be made without departing from the scope described herein. Various aspects are capable of other embodiments and of being practiced or being carried out in various different ways.

As a general introduction to the subject matter described in more detail below, aspects described herein are directed towards configuring and implementing a client side versatile data virtualization driver. For example, data virtualization server overhead may be reduced by modifying the virtualization server to dynamically provision a new type of virtualization driver. This driver may be a versatile data virtualization driver with code extensions and data access parameters that may allow for the retrieval of the query results directly by the data virtualization client without involving the server.

It is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof. The use of the terms “mounted,” “connected,” “coupled,” “positioned,” “engaged” and similar terms, is meant to include both direct and indirect mounting, connecting, coupling, positioning and engaging.

### Computing Architecture

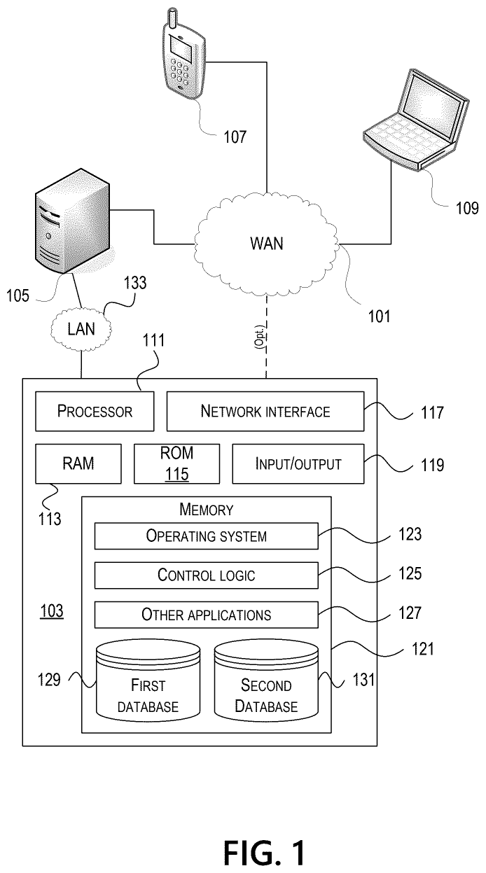

Computer software, hardware, and networks may be utilized in a variety of different system environments, including standalone, networked, remote-access (also known as remote desktop), virtualized, and/or cloud-based environments, among others. FIG. 1 illustrates one example of a system architecture and data processing device that may be used to implement one or more illustrative aspects described herein in a standalone and/or networked environment. Various network nodes 103, 105, 107, and 109 may be interconnected via a wide area network (WAN) 101, such as the Internet. Other networks may also or alternatively be used, including private intranets, corporate networks, local area networks (LAN), metropolitan area networks (MAN), wireless networks, personal networks (PAN), and the like. Network 101 is for illustration purposes and may be replaced with fewer or additional computer networks. A local area network 133 may have one or more of any known LAN topology and may use one or more of a variety of different protocols, such as Ethernet. Devices 103, 105, 107, and 109 and other devices (not shown) may be connected to one or more of the networks via twisted pair wires, coaxial cable, fiber optics, radio waves, or other communication media.

The term “network” as used herein and depicted in the drawings refers not only to systems in which remote storage devices are coupled together via one or more communication paths, but also to stand-alone devices that may be coupled, from time to time, to such systems that have storage capability. Consequently, the term “network” includes not only a “physical network” but also a “content network,” which is comprised of the data-attributable to a single entity-which resides across all physical networks.

The components may include data server 103, web server 105, and client computers 107, 109. Data server 103 provides overall access, control and administration of databases and control software for performing one or more illustrative aspects described herein. Data server 103 may be connected to web server 105 through which users interact with and obtain data as requested. Alternatively, data server 103 may act as a web server itself and be directly connected to the Internet. Data server 103 may be connected to web server 105 through the local area network 133, the wide area network 101 (e.g., the Internet), via direct or indirect connection, or via some other network. Users may interact with the data server 103 using remote computers 107, 109, e.g., using a web browser to connect to the data server 103 via one or more externally exposed web sites hosted by web server 105. Client computers 107, 109 may be used in concert with data server 103 to access data stored therein, or may be used for other purposes. For example, from client device 107 a user may access web server 105 using an Internet browser, as is known in the art, or by executing a software application that communicates with web server 105 and/or data server 103 over a computer network (such as the Internet).

Servers and applications may be combined on the same physical machines, and retain separate virtual or logical addresses, or may reside on separate physical machines. FIG. 1 illustrates just one example of a network architecture that may be used, and those of skill in the art will appreciate that the specific network architecture and data processing devices used may vary, and are secondary to the functionality that they provide, as further described herein. For example, services provided by web server 105 and data server 103 may be combined on a single server.

Each component 103, 105, 107, 109 may be any type of known computer, server, or data processing device. Data server 103, e.g., may include a processor 111 controlling overall operation of the data server 103. Data server 103 may further include random access memory (RAM) 113, read only memory (ROM) 115, network interface 117, input/output interfaces 119 (e.g., keyboard, mouse, display, printer, etc.), and memory 121. Input/output (I/O) 119 may include a variety of interface units and drives for reading, writing, displaying, and/or printing data or files. Memory 121 may further store operating system software 123 for controlling overall operation of the data processing device 103, control logic 125 for instructing data server 103 to perform aspects described herein, and other application software 127 providing secondary, support, and/or other functionality which may or might not be used in conjunction with aspects described herein. The control logic 125 may also be referred to herein as the data server software 125. Functionality of the data server software 125 may refer to operations or decisions made automatically based on rules coded into the control logic 125, made manually by a user providing input into the system, and/or a combination of automatic processing based on user input (e.g., queries, data updates, etc.).

Memory 121 may also store data used in performance of one or more aspects described herein, including a first database 129 and a second database 131. In some embodiments, the first database 129 may include the second database 131 (e.g., as a separate table, report, etc.). That is, the information can be stored in a single database, or separated into different logical, virtual, or physical databases, depending on system design. Devices 105, 107, and 109 may have similar or different architecture as described with respect to device 103. Those of skill in the art will appreciate that the functionality of data processing device 103 (or device 105, 107, or 109) as described herein may be spread across multiple data processing devices, for example, to distribute processing load across multiple computers, to segregate transactions based on geographic location, user access level, quality of service (QoS), etc.

One or more aspects may be embodied in computer-usable or readable data and/or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) HyperText Markup Language (HTML) or Extensible Markup Language (XML). The computer executable instructions may be stored on a computer readable medium such as a nonvolatile storage device. Any suitable computer readable storage media may be utilized, including hard disks, CD-ROMs, optical storage devices, magnetic storage devices, solid state storage devices, and/or any combination thereof. In addition, various transmission (non-storage) media representing data or events as described herein may be transferred between a source and a destination in the form of electromagnetic waves traveling through signal-conducting media such as metal wires, optical fibers, and/or wireless transmission media (e.g., air and/or space). Various aspects described herein may be embodied as a method, a data processing system, or a computer program product. Therefore, various functionalities may be embodied in whole or in part in software, firmware, and/or hardware or hardware equivalents such as integrated circuits, field programmable gate arrays (FPGA), and the like. Particular data structures may be used to more effectively implement one or more aspects described herein, and such data structures are contemplated within the scope of computer executable instructions and computer-usable data described herein.

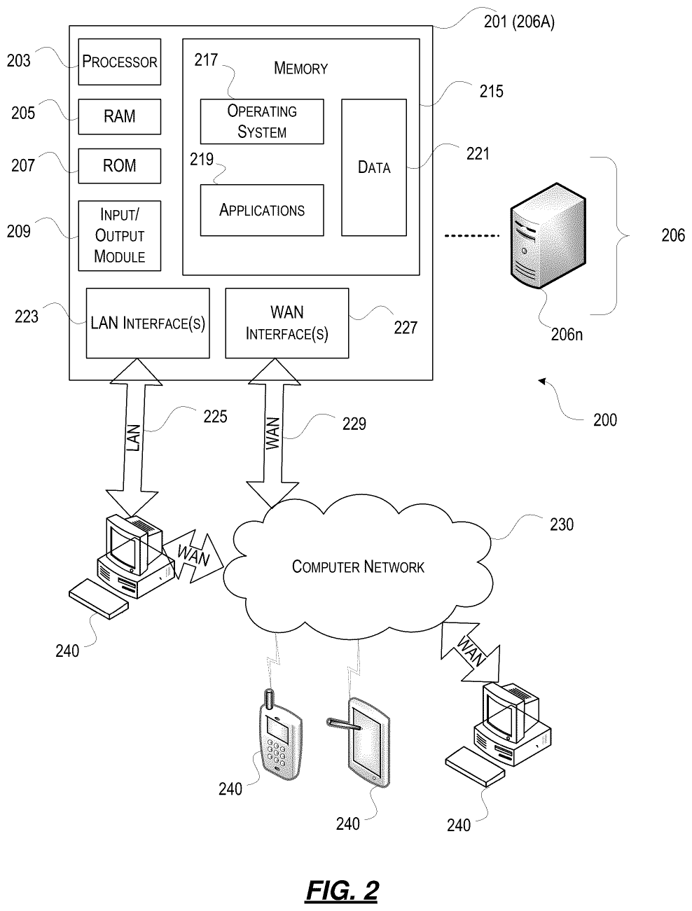

With further reference to FIG. 2, one or more aspects described herein may be implemented in a remote-access environment. FIG. 2 depicts an example system architecture including a computing device 201 in an illustrative computing environment 200 that may be used according to one or more illustrative aspects described herein. Computing device 201 may be used as a server 206a in a single-server or multi-server desktop virtualization system (e.g., a remote access or cloud system) and can be configured to provide virtual machines for client access devices. The computing device 201 may have a processor 203 for controlling overall operation of the device 201 and its associated components, including RAM 205, ROM 207, Input/Output (I/O) module 209, and memory 215.

I/O module 209 may include a mouse, keypad, touch screen, scanner, optical reader, and/or stylus (or other input device(s)) through which a user of computing device 201 may provide input, and may also include one or more of a speaker for providing audio output and one or more of a video display device for providing textual, audiovisual, and/or graphical output. Software may be stored within memory 215 and/or other storage to provide instructions to processor 203 for configuring computing device 201 into a special purpose computing device in order to perform various functions as described herein. For example, memory 215 may store software used by the computing device 201, such as an operating system 217, application programs 219, and an associated database 221.

Computing device 201 may operate in a networked environment supporting connections to one or more remote computers, such as terminals 240 (also referred to as client devices and/or client machines). The terminals 240 may be personal computers, mobile devices, laptop computers, tablets, or servers that include many or all of the elements described above with respect to the computing device 103 or 201. The network connections depicted in FIG. 2 include a local area network (LAN) 225 and a wide area network (WAN) 229, but may also include other networks. When used in a LAN networking environment, computing device 201 may be connected to the LAN 225 through a network interface or adapter 223. When used in a WAN networking environment, computing device 201 may include a modem or other wide area network interface 227 for establishing communications over the WAN 229, such as computer network 230 (e.g., the Internet). It will be appreciated that the network connections shown are illustrative and other means of establishing a communications link between the computers may be used. Computing device 201 and/or terminals 240 may also be mobile terminals (e.g., mobile phones, smartphones, personal digital assistants (PDAs), notebooks, etc.) including various other components, such as a battery, speaker, and antennas (not shown).

Aspects described herein may also be operational with numerous other general purpose or special purpose computing system environments or configurations. Examples of other computing systems, environments, and/or configurations that may be suitable for use with aspects described herein include, but are not limited to, personal computers, server computers, hand-held or laptop devices, multiprocessor systems, microprocessor-based systems, set top boxes, programmable consumer electronics, network personal computers (PCs), minicomputers, mainframe computers, distributed computing environments that include any of the above systems or devices, and the like.

As shown in FIG. 2, one or more client devices 240 may be in communication with one or more servers 206a-206n (generally referred to herein as “server(s) 206”). In one embodiment, the computing environment 200 may include a network appliance installed between the server(s) 206 and client machine(s) 240. The network appliance may manage client/server connections, and in some cases can load balance client connections amongst a plurality of backend servers 206.

The client machine(s) 240 may in some embodiments be referred to as a single client machine 240 or a single group of client machines 240, while server(s) 206 may be referred to as a single server 206 or a single group of servers 206. In one embodiment a single client machine 240 communicates with more than one server 206, while in another embodiment a single server 206 communicates with more than one client machine 240. In yet another embodiment, a single client machine 240 communicates with a single server 206.

A client machine 240 can, in some embodiments, be referenced by any one of the following non-exhaustive terms: client machine(s); client(s); client computer(s); client device(s); client computing device(s); local machine; remote machine; client node(s); endpoint(s); or endpoint node(s). The server 206, in some embodiments, may be referenced by any one of the following non-exhaustive terms: server(s), local machine; remote machine; server farm(s), or host computing device(s).

In one embodiment, the client machine 240 may be a virtual machine. The virtual machine may be any virtual machine, while in some embodiments the virtual machine may be any virtual machine managed by a Type 1 or Type 2 hypervisor, for example, a hypervisor developed by Citrix Systems, IBM, VMware, or any other hypervisor. In some aspects, the virtual machine may be managed by a hypervisor, while in other aspects the virtual machine may be managed by a hypervisor executing on a server 206 or a hypervisor executing on a client 240.

Some embodiments include a client device 240 that displays application output generated by an application remotely executing on a server 206 or other remotely located machine. In these embodiments, the client device 240 may execute a virtual machine receiver program or application to display the output in an application window, a browser, or other output window. In one example, the application is a desktop, while in other examples the application is an application that generates or presents a desktop. A desktop may include a graphical shell providing a user interface for an instance of an operating system in which local and/or remote applications can be integrated. Applications, as used herein, are programs that execute after an instance of an operating system (and, optionally, also the desktop) has been loaded.

A remote computing environment may include more than one server 206a-206n such that the servers 206a-206n are logically grouped together into a server farm 206, for example, in a cloud computing environment. The server farm 206 may include servers 206 that are geographically dispersed while logically grouped together, or servers 206 that are located proximate to each other while logically grouped together. Geographically dispersed servers 206a-206n within a server farm 206 can, in some embodiments, communicate using a WAN (wide), MAN (metropolitan), or LAN (local), where different geographic regions can be characterized as: different continents; different regions of a continent; different countries; different states; different cities; different campuses; different rooms; or any combination of the preceding geographical locations. In some embodiments the server farm 206 may be administered as a single entity, while in other embodiments the server farm 206 can include multiple server farms.

In some embodiments, a server farm may include servers 206 that execute a substantially similar type of operating system platform (e.g., WINDOWS, UNIX, LINUX, IOS, ANDROID, etc.) In other embodiments, server farm 206 may include a first group of one or more servers that execute a first type of operating system platform, and a second group of one or more servers that execute a second type of operating system platform.

Server 206 may be configured as any type of server, as needed, e.g., a file server, an application server, a web server, a proxy server, an appliance, a network appliance, a gateway, an application gateway, a gateway server, a virtualization server, a deployment server, a Secure Sockets Layer (SSL) VPN server, a firewall, a web server, an application server or as a master application server, a server executing an active directory, or a server executing an application acceleration program that provides firewall functionality, application functionality, or load balancing functionality. Other server types may also be used.

Some embodiments include a first server 206a that receives requests from a client machine 240, forwards the request to a second server 206b (not shown), and responds to the request generated by the client machine 240 with a response from the second server 206b (not shown.) First server 206a may acquire an enumeration of applications available to the client machine 240 as well as address information associated with an application server 206 hosting an application identified within the enumeration of applications. First server 206a can then present a response to the client's request using a web interface, and communicate directly with the client 240 to provide the client 240 with access to an identified application. One or more clients 240 and/or one or more servers 206 may transmit data over network 230, e.g., network 101.

### Versatile Data Virtualization Driver

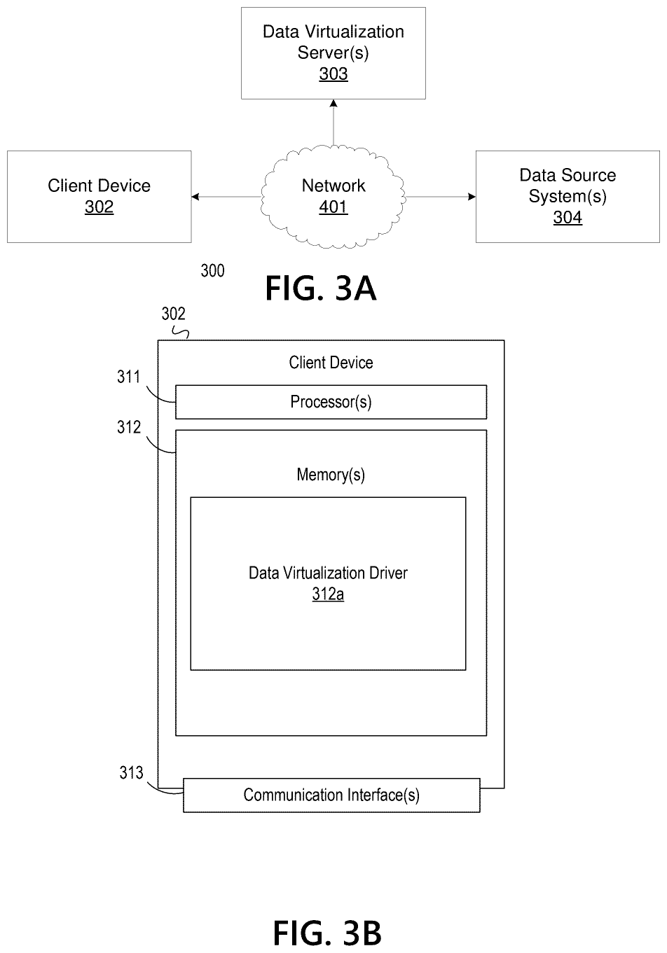

FIGS. 3A-3B depict an illustrative computing environment for performing configuring and implementing a versatile data virtualization driver in accordance with one or more example embodiments. Referring to FIG. 3A, computing environment 300 may include one or more computer systems. For example, computing environment 300 may include a client device 302, data virtualization server(s) 303, and data source system(s) 304.

As illustrated in greater detail below, client device 302 may be a personal computing device such as a smartphone, tablet, laptop computer, desktop computer, or the like. In some instances, client device 302 may be configured to display data views, submit data source queries, or the like, and thus may be configured to communicate with the data virtualization server(s) 303. In some instances, the client device 302 may be configured with a versatile data virtualization driver configured to bypass the data virtualization server(s) 303 in obtaining query results from the data source system(s) 304. Although a single client device is depicted, any number of such devices may be implemented in the methods described herein without departing from the scope of the disclosure.

Data virtualization server(s) 303 may be a computer system that includes one or more computing devices (e.g., servers, server blades, or the like) and/or other computer components (e.g., processors, memories, communication interfaces). In one or more instances, data virtualization server(s) 303 may be configured to support the facilitation of queries between the client device 302 and data source system(s) 304. For example, the data virtualization server(s) 303 may be configured to perform query translation into a native format of a specified data source system. Furthermore, the data virtualization server(s) 303 may be configured to provision a versatile data virtualization driver to the client device 302.

Data source system(s) 304 may include one or more servers or the like configured for data storage. In some instances, data source system(s) 304 may correspond to different databases, data providers, file systems, application programming interfaces (APIs), access points, and/or other data storage sources. In some instances, different systems of the data source system(s) 304 may be formatted in unique formats, languages, or the like. Accordingly, where queries are received for processing by such data source system(s) 304, such queries may be formatted according to the unique format, language, or the like of the corresponding data source system 304. Data source system(s) 304 may include any number of systems without departing from the scope of the disclosure.

Computing environment 300 may also include one or more networks, which may interconnect client device 302, data virtualization server(s) 303, and data source system(s) 304. For example, computing environment 300 may include a wired or wireless network 301 (which may e.g., connect client device 302, data virtualization server(s) 303, and data source system(s) 304).

In one or more arrangements, client device 302, data virtualization server(s) 303, data source system(s) 304, and/or the other systems included in the computing environment may be any type of computing device capable of receiving a user interface, receiving input via the user interface, and communicating the received input to one or more other computing devices. For example, client device 302, data virtualization server(s) 303, data source system(s) 304, and/or the other systems included in the computing environment may in some instances, be and/or include server computers, desktop computers, laptop computers, tablet computers, smart phones, or the like that may include one or more processors, memories, communication interfaces, storage devices, and/or other components. As noted above, and as illustrated in greater detail below, any and/or all of client device 302, data virtualization server(s) 303, and data source system(s) 304 may, in some instances, be special purpose computing devices configured to perform specific functions.

Referring to FIG. 3B, client device 302 may include one or more processors 311, memory 312, and communication interface 313. A data bus may interconnect processor 311, memory 312, and communication interface 313. Communication interface 313 may be a network interface configured to support communication between the client device 302 and one or more networks (e.g., network 301, or the like). Memory 312 may include one or more program modules having instructions that when executed by processor 311 cause client device 302 to perform one or more functions described herein and/or access one or more databases that may store and/or otherwise maintain information which may be used by such program modules and/or processor 311. In some instances, the one or more program modules and/or databases may be stored by and/or maintained in different memory units of client device 302 and/or by different computing devices that may form and/or otherwise make up client device 302. For example, memory 312 may have, host, store, and/or include a data virtualization driver 312a that may direct and/or otherwise cause client device 302 to configure and implement a versatile data virtualization driver to facilitate query processing against a plurality of data source system(s) 304.

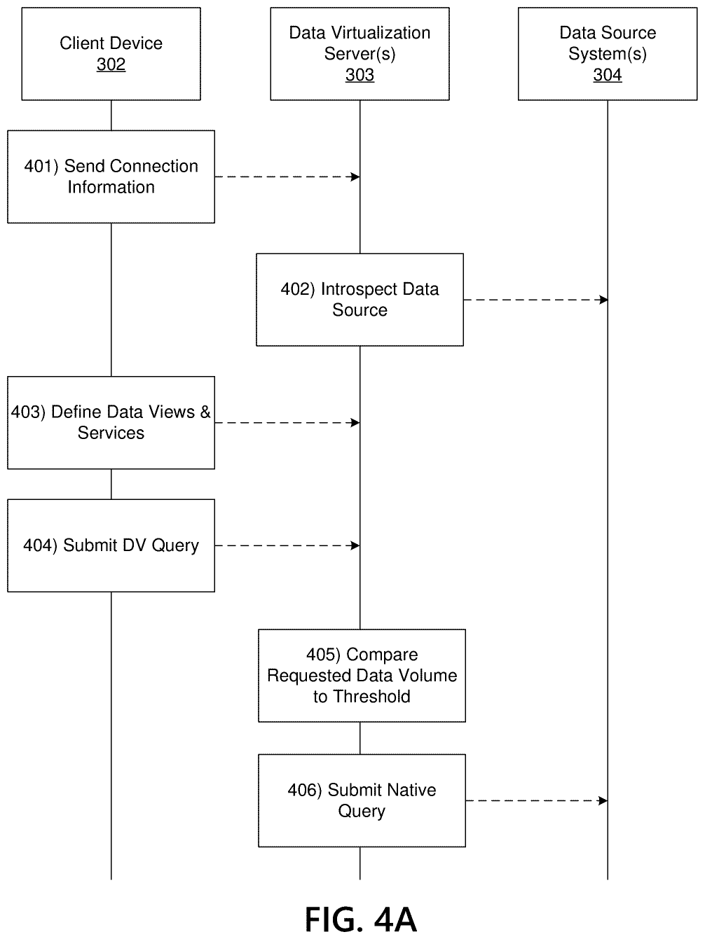

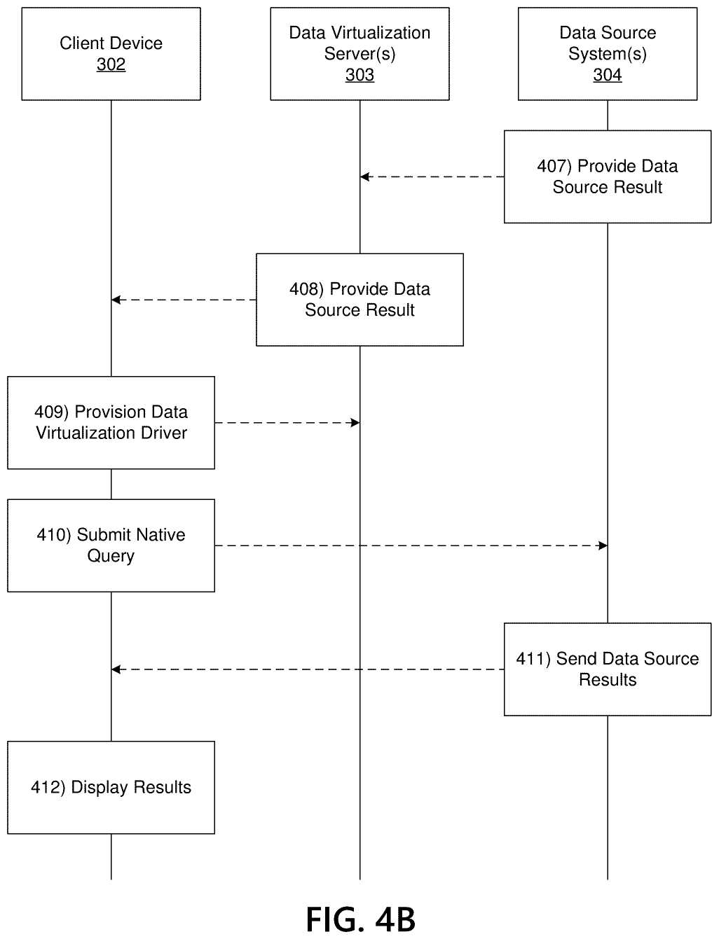

FIGS. 4A-4B depict an illustrative event sequence for configuring and implementing a versatile data virtualization driver in accordance with one or more example embodiments. It should be understood that steps 401-412 may, in some instances, occur in the order as shown with regard to FIGS. 4A-4B. For example, after completing step 406 of FIG. 4A, the event sequence may proceed to step 407 of FIG. 4B.

Referring to FIG. 4A, at step 401, the client device 302 may send data source connection information (e.g., information used to connect to the data source(s)) 304) to the data virtualization server(s) 303. For example, this data source connection information may include connection properties, which may have been specified by, for example developers using various design tools. Although step 401 is depicted as being performed by the client device 302, these actions may be performed by a different user device (such as a user device operated by a developer), without departing from the scope of the disclosure. For example, the client device 302 may be a plain client device and/or a user device operated by a developer that may be distinct from a plain client device, such as a Studio device.

At step 402, the data virtualization server(s) 303 may use the data source connection information to introspect the data source system(s) 304. For example, the data virtualization server(s) 303 may be provisioned by information technology (IT) teams with data source specific drivers, which may be used to communicate with the data source system(s) 304. For example, the data virtualization server(s) 303 may create a connection with these data source system(s) 304 and/or obtain metadata and/or other information from these data source system(s) 304 that may enable the data virtualization server(s) 303 to generate native queries to access information at these data source system(s) 304. In some instances, the data virtualization server(s) 303 may store and/or otherwise persist this metadata and/or other information in a metadata repository at the data virtualization server(s) 303.

At step 403, the client device 302 may communicate with the data virtualization server(s) 303 to define one or more data views, services, or the like. For example, in defining the data views, the client device 302 and/or data virtualization server(s) 303 may define composite data views based on the use of one or more data assets from a single source of the data source system(s) 304. Once these data views are defined, they may be published as data services, which may, e.g., be accessed by clients at runtime. Although step 403 is depicted as being performed by the client device 302, these actions may be performed by a different user device (such as a Studio device operated by a developer), without departing from the scope of the disclosure.

While steps 401-403 pertain to the design time aspects of the event sequence, the remaining steps pertain to runtime.

At step 404, the client device 302 may submit a data virtualization query to the data virtualization server(s) 303. For example, the client device 302 may submit a data virtualization query requesting some portion of data hosted by one or more of the data source system(s) 304. In some instances, prior to submitting the data virtualization query, the client device 302 may use a data virtualization driver to introspect data virtualization data services from the data virtualization server(s) 303 (which may, e.g., include the data services defined at step 403). In these instances, the client device 302 may submit the data virtualization query based on these introspected data virtualization data services. In some instances, in submitting the data virtualization query, the client device 302 may submit the data virtualization query through a particular application executing at the client device 302.

At step 405, the data virtualization server(s) 303 may identify a volume of data requested in the data virtualization query, and may compare this volume of data to a virtualization threshold. In instances where the data virtualization server(s) 303 identifies that the volume of data meets or exceeds the virtualization threshold, the data virtualization server(s) 303 may proceed to step 409. Otherwise, if the data virtualization server(s) 303 identifies that the volume of data fails to meet or exceed the virtualization threshold, the data virtualization server(s) 303 may proceed to step 406.

Similarly, the data virtualization server(s) 303 may, in some instances, identify whether or not the data virtualization query is requested data from more than one of the data source system(s) 304. If the data virtualization server(s) 303 identifies that data is requested from multiple data source system(s) 304, the data virtualization server(s) 303 may proceed to step 406 regardless of the amount of data requested. In contrast, if the data virtualization server(s) 303 identifies that data is requested from a single data source system 304, the data virtualization server(s) 303 may compare the requested data volume to the virtualization threshold as described above.

Similarly, the data virtualization server(s) 303 may, in some instances, identify whether or not the data virtualization driver has already been provisioned at the client device 302. In these instances, if the data virtualization driver has already been provisioned, the event sequence may proceed to step 410. Otherwise, if the data virtualization driver has not yet been provisioned, the data virtualization server(s) 303 may compare the requested data volume to the virtualization threshold as described above.

At step 406, the data virtualization server(s) 303 may translate the data virtualization query into a native format corresponding to the intended data source system(s) 304. For example, the data virtualization server(s) 303 may receive the data virtualization query and, based on a definition of underlying integration data views, restrictions imposed by any relevant security policies, and/or other information, translate the data virtualization query into a native data source query that may be submitted against the intended data source system(s) 304.

Referring to FIG. 4B, at step 407, the data source system(s) 304 may identify a data result to satisfy the data virtualization query, and may provide and/or otherwise propagate this data source result to the data virtualization server(s) 303.

At step 408, the data virtualization server(s) 303 may provide the data source result received at step 407 to the client device 302. Accordingly, in steps 407/408, the data source system(s) 304 may propagate the data source result to the client device 302 via the data virtualization server(s) 303. In these instances, the client device 302 may cause display of the data source result (e.g., via the particular application currently launched at the client device 302).

Returning to step 405, if the data virtualization server(s) 303 identified that the requested data volume did meet or exceed the virtualization threshold, the event sequence may have proceeded directly to step 409. At step 409, the client device 302 and the data virtualization server(s) 303 may communicate to provision a versatile data virtualization driver. In doing so, the client device 302 may configure the data virtualization driver to bypass the data virtualization server(s) 303 for direct data retrieval from the data source system(s) 304. For example, the data virtualization server(s) 303 may send data source connection information to the client device 302, which may be used to establish a connection between client device 302 and the data source systems(s) 304 (e.g., using the versatile data virtualization driver). For example, the virtualization server(s) may send a driver native to the data source system(s) 304, which may be coded in binary files, to the client device 302. Additionally, the data virtualization server(s) 303 may send a native query (corresponding to the data virtualization query) to the client device 302. For example, the data virtualization server(s) 303 may receive the data virtualization query and, based on a definition of underlying integration data views, restrictions imposed by any relevant security policies, and/or other information, translate the data virtualization query into a native data source query that may be submitted against the intended data source system(s) 304. In some instances, the data virtualization server(s) 303 may also send one or more provision partition clauses, which may, e.g., be used by the client device 302 to parallelize the data transfer of query results from the data source system(s) 304. More specifically, these provision partition clauses may specify natural breakpoints in a corresponding data source result, which may, e.g., define subsets (e.g., sub-results) of the data source result that may be sent back to the client device 302 as separate results (and subsequently reconstructed at the client device 302).

Once received, the client device 302 may use this received information to provision the versatile data virtualization driver, which may, e.g., enable the client device 302 to communicate with the data source system(s) 304 in a versatile manner. More specifically, rather than limiting communication of the client device 302 to solely the data virtualization server(s) 303, the versatile data virtualization driver may enable communication between the client device 302 and any number of different data source system(s) 304. Doing so may, for example, reduce a number of hops associated with the transmission of queries and results between the client device 302 and the data source system(s) 304 (e.g., by eliminating the communication via the data virtualization server(s) 303). Similarly, this may reduce a processing load on the data virtualization server(s) 303 itself.

In some instances, in provisioning the data virtualization driver, the client device 302 may cache the native query received from the data virtualization server(s) 303. In doing so, the client device 302 may avoid communication with the data virtualization server(s) 303 to obtain the native query in future instances where the same data virtualization query is received. In some instances, the client device 302 may cache the native query based on a likelihood of subsequently receiving the same query, historical query information for the application, and/or other query/application information. For example, if the client device 302 identifies that the likelihood of receiving the same query is equal to or greater than a predetermined threshold, the client device 302 may cache the native query. In contrast, if the client device 302 identifies that the likelihood of receiving the same query is less than the predetermined threshold, the client device 302 might not cache the native query. In some instances, the client device 302 may cache queries on an application by application basis (e.g., first queries for a first application, second queries for a second application, or the like). For example, instances of the versatile data virtualization driver may be specific to each application. In other instances, a single versatile data virtualization driver may be used at the client device 302, which controls query execution for a plurality of applications.

Although provisioning/configuration of the versatile data virtualization driver is illustrated as being performed once the data virtualization query is received, in some instances, such provisioning/configuration may be performed in advance of receipt of the data virtualization query. For example, the versatile data virtualization driver may be preconfigured in some instances. In these instances, the versatile data virtualization driver may be preconfigured with drivers and connection information for certain databases known to be accessed by certain applications (e.g., based on application information, historical query information, and/or otherwise).

At step 410, the client device 302 may submit the native query, received at step 409, directly to the relevant data source system 304. For example, just as the data virtualization server(s) 303 submitted the native query to the relevant data source system 304 at step 406, at step 410, the client device 302 itself may submit the native query, thus eliminating the need to transmit the data virtualization query via the data virtualization server(s) 303.

At step 411, the data source system(s) 304 may identify a data result to satisfy the native query, and may provide and/or otherwise propagate this data source result to the client device 302 (e.g., rather than transmitting the data source result to the client device 302 via the data virtualization server(s) 303 as described above at steps 407/408). In some instances, where provision partition clauses were included with the native query, the data source system(s) 304 may split the data source result into a plurality of sub-results (e.g., rather than sending four rows of data as a single result, a first sub-result including the first two rows and a second sub-result including the second two rows—as defined by the provision partition clauses—may be sent to the client device 302). In these instances, the data source system(s) 304 may provide these sub-results to the client device 302 in parallel streams based on the partition clauses.

At step 412, the client device 302 may cause display of the data source result (e.g., via the particular application currently launched at the client device 302). In some instances, this may involve restoring various sub-results to an overall data source result based on the provision partition clauses.

Additionally or alternatively, the client device 302 may send, to the data virtualization server(s) 303, an indication of the outcome of the native query (e.g., success, failure, cancellation, or the like). In some instances, along with this indication, the client device 302 may also send back the amount of data (e.g., number of rows, bytes, or the like) received, an error message related to the failure, and/or other information. In doing so, the data virtualization server(s) 303 may maintain a level of use of each data source by different clients.

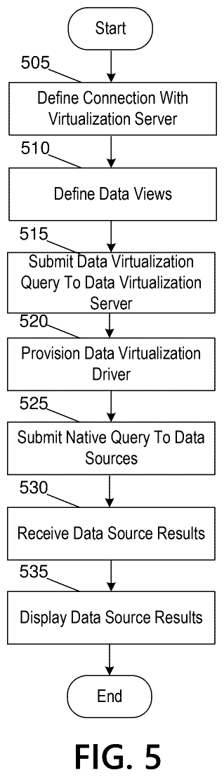

FIG. 5 depicts an illustrative method for configuring and implementing a versatile data virtualization driver in accordance with one or more example embodiments. Referring to FIG. 5, at step 505, a computing system comprising a memory and one or more processors may define a connection with a virtualization server. At step 510, the computing system and virtualization server may communicate to define data views associated with one or more data source systems. At step 515, the computing system may submit a data virtualization query to the virtualization server. At step 520, the computing system may provision a data virtualization driver (e.g., by communicating with the virtualization server). At step 525, the computing system may submit a native query (corresponding to the data virtualization query) to a corresponding data source. At step 530, the computing system may receive data source results in response to the native query. At step 535, the computing system may display the data source results.

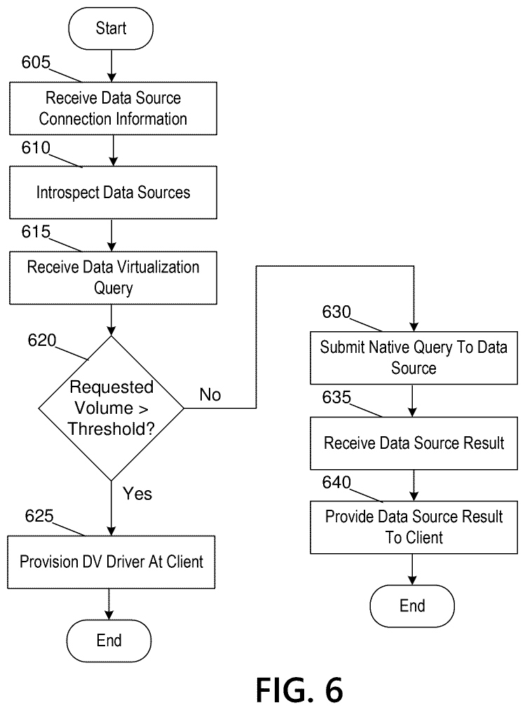

FIG. 6 depicts an illustrative method for configuring and implementing a versatile data virtualization driver in accordance with one or more example embodiments. Referring to FIG. 6, at step 605, a computing system comprising a memory and one or more processors may receive data source connection information from a client device. At step 610, the computing system may introspect one or more data source systems. At step 615, the computing system may receive a data virtualization query from a client device. At step 620, the computing system may identify whether or not a requested data volume meets or exceeds a threshold. If the threshold is met or exceeded, the computing system may proceed to step 625. At step 625, the computing system may communicate with the client device to provision a versatile data virtualization driver at the client device.

Returning to step 620, if the threshold is not met or exceeded, the computing system may proceed to step 630. At step 630, the computing system may translate the data virtualization query to a native query and submit the native query to the corresponding data source system. At step 635, the computing system may receive a data source result from the data source system. At step 640, the computing system may provide the data source result to the client device.

The following paragraphs (M1) through (M11) describe examples of methods that may be implemented in accordance with the present disclosure.

(M1) A method comprising: transmitting, by a client device and to a virtualization server, a data virtualization query directed to a data source; receiving, by the client device and from the virtualization server, driver provision information comprising data source connection information for the data source and a native version of the data virtualization query; provisioning, at the client device and using the driver provision information, a data virtualization driver corresponding to the data source, wherein the data virtualization driver is configured to bypass the virtualization server for direct data retrieval from the data source; transmitting, to the data source and using the data virtualization driver, the native version of the data virtualization query; receiving, from the data source, data source results; and displaying the data source results.

(M2) A method may be performed as described in paragraph (M1) further comprising: prior to transmitting the data virtualization query, transmitting, to the virtualization server, connection information for the data source, wherein the connection information is used to introspect the data source.

(M3) A method may be performed as described in any one of paragraphs (M1) or (M2) further comprising prior to transmitting the data virtualization query, defining a plurality of data views, wherein the data virtualization query is expressed in terms of one of the plurality of data views.

(M4) A method may be performed as described in any of paragraphs (M1)-(M3), wherein the virtualization server is further configured to: identify a data quantity requested by the data virtualization query, and compare the data quantity to a data volume threshold.

(M5) A method may be performed as described in paragraph (M4), wherein the virtualization server is further configured to: send, based on identifying that the data quantity meets or exceeds the data volume threshold, the driver provision information.

(M6) A method may be performed as described in any one of paragraphs (M4) or (M5), wherein the virtualization server is further configured to: based on identifying that the data quantity is less than the data volume threshold: transmit the native query to the data source, receive, from the data source, the data source results, and transmit, to the client device, the data source results.

(M7) A method may be performed as described in any one of paragraphs (M1)-(M6), wherein the data virtualization query comprises a query for a single data source of the data source.

(M8) A method may be performed as described in any one of paragraphs (M1)-(M7), further comprising: caching, using the data virtualization driver, the native version of the data virtualization query.

(M9) A method may be performed as described in paragraph (M9), wherein the caching is based on predicted queries to be sent from the client device for a particular application.

(M10) A method may be performed as described in any of paragraphs (M1) through (M9) wherein the data virtualization driver is specific to an application at the client device.

(M11) A method may be performed as described in any of paragraphs (M1) through (M10), wherein the driver provision information further includes provision partition clauses defining logical breakpoints used to split the data source result into a plurality of sub-results.

The following paragraphs (A1) through (A8) describe examples of apparatuses that may be implemented in accordance with the present disclosure.

(A1) A computing system comprising: one or more processors; memory storing computer executable instructions that, when executed by the processor, cause the computing system to: transmit, by a client device and to a virtualization server, a data virtualization query directed to a data source; receive, by the client device and from the virtualization server, driver provision information comprising data source connection information for the data source and a native version of the data virtualization query; provision, at the client device and using the driver provision information, a data virtualization driver corresponding to the data source, wherein the data virtualization driver is configured to bypass the virtualization server for direct data retrieval from the data source; transmit, to the data source and using the data virtualization driver, the native version of the data virtualization query; receive, from the data source, data source results; and display the data source results.

(A2) The computing system as described in paragraph (A1), wherein the memory stores additional computer executable instructions that, when executed by the one or more processors, cause the computing system to: prior to transmitting the data virtualization query, transmit, to the virtualization server, connection information for the data source, wherein the connection information is used to introspect the data source.

(A3) The computing system as described in any of paragraphs (A1) or (A2), wherein the memory stores additional computer executable instructions that, when executed by the one or more processors, cause the computing system to: prior to transmitting the data virtualization query, define a plurality of data views, wherein the data virtualization query is expressed in terms of one of the plurality of data views.

(A4) The computing system as described in any of paragraphs (A1) through (A3), wherein the virtualization server is further configured to: identify a data quantity requested by the data virtualization query, and compare the data quantity to a data volume threshold.

(A5) The computing system as described in paragraph (A4), wherein the virtualization server is further configured to: send, based on identifying that the data quantity meets or exceeds the data volume threshold, the driver provision information.

(A6) The computing system as described in any of paragraphs (A4) or (A5), wherein the virtualization server is further configured to: based on identifying that the data quantity is less than the data volume threshold: transmit the native query to the data source, receive, from the data source, the data source results, and transmit, to the client device, the data source results.

(A7) The computing system as described in any of paragraphs (A1) through (A6), wherein the data virtualization query comprises a query for a single data source of the data source.

(A8) The computing system as described in any of paragraphs (A1) through (A7), wherein the memory stores additional computer executable instructions that, when executed by the one or more processors, cause the computing system to: cache, using the data virtualization driver, the native version of the data virtualization query.

The following paragraph (CRM1) describes examples of computer-readable media that may be implemented in accordance with the present disclosure.

(CRM1) A non-transitory computer-readable medium storing instructions that, when executed, cause a system to perform transmit, by a client device and to a virtualization server, a data virtualization query directed to a data source; receive, by the client device and from the virtualization server, driver provision information comprising data source connection information for the data source and a native version of the data virtualization query; provision, at the client device and using the driver provision information, a data virtualization driver corresponding to the data source, wherein the data virtualization driver is configured to bypass the virtualization server for direct data retrieval from the data source; transmit, to the data source and using the data virtualization driver, the native version of the data virtualization query; receive, from the data source, data source results; and display the data source results.

Although the subject matter has been described in language specific to structural features and/or methodological acts, it is to be understood that the subject matter defined in the appended claims is not necessarily limited to the specific features or acts described above. Rather, the specific features and acts described above are described as example implementations of the following claims.

What is claimed is:

1. A method comprising:
transmitting, by a client device and to a virtualization server, a data virtualization query directed to a data source;
receiving, by the client device and from the virtualization server, driver provision information comprising data source connection information for the data source and a native version of the data virtualization query;
provisioning, at the client device and using the driver provision information, a data virtualization driver corresponding to the data source, wherein the data virtualization driver is configured to bypass the virtualization server for direct data retrieval from the data source;
transmitting, to the data source and using the data virtualization driver, the native version of the data virtualization query;
receiving, from the data source, data source results; and
displaying the data source results.

2. The method of claim 1, further comprising:
prior to transmitting the data virtualization query, transmitting, to the virtualization server, connection information for the data source, wherein the connection information is used to introspect the data source.

3. The method of claim 1, further comprising:
prior to transmitting the data virtualization query, defining a plurality of data views, wherein the data virtualization query is expressed in terms of one of the plurality of data views.

4. The method of claim 1, wherein the virtualization server is further configured to:
identify a data quantity requested by the data virtualization query, and
compare the data quantity to a data volume threshold.

5. The method of claim 4, wherein the virtualization server is further configured to:
send, based on identifying that the data quantity meets or exceeds the data volume threshold, the driver provision information.

6. The method of claim 4, wherein the virtualization server is further configured to:
based on identifying that the data quantity is less than the data volume threshold:
transmit the native query to the data source,
receive, from the data source, the data source results, and
transmit, to the client device, the data source results.

7. The method of claim 1, wherein the data virtualization query comprises a query for a single data source of the data source.

8. The method of claim 1, further comprising:
caching, using the data virtualization driver, the native version of the data virtualization query.

9. The method of claim 8, wherein the caching is based on predicted queries to be sent from the client device for a particular application.

10. The method of claim 1, wherein the data virtualization driver is specific to an application at the client device.

11. The method of claim 1, wherein the driver provision information further includes provision partition clauses defining logical breakpoints used to split the data source result into a plurality of sub-results.

12. A computing system comprising:
one or more processors;
memory storing computer executable instructions that, when executed by the processor, cause the computing system to:
transmit, to a virtualization server, a data virtualization query directed to a data source;
receive, from the virtualization server, driver provision information comprising data source connection information for the data source and a native version of the data virtualization query;
provision, using the driver provision information, a data virtualization driver corresponding to the data source, wherein the data virtualization driver is configured to bypass the virtualization server for direct data retrieval from the data source;
transmit, to the data source and using the data virtualization driver, the native version of the data virtualization query;
receive, from the data source, data source results; and
display the data source results.

13. The computing system of claim 12, wherein the memory stores additional computer executable instructions that, when executed by the one or more processors, cause the computing system to:
prior to transmitting the data virtualization query, transmit, to the virtualization server, connection information for the data source, wherein the connection information is used to introspect the data source.

14. The computing system of claim 12, wherein the memory stores additional computer executable instructions that, when executed by the one or more processors, cause the computing system to:
prior to transmitting the data virtualization query, define a plurality of data views, wherein the data virtualization query is input via one of the plurality of data views.

15. The computing system of claim 12, wherein the virtualization server is further configured to:
identify a data quantity requested by the data virtualization query, and
compare the data quantity to a data volume threshold.

16. The computing system of claim 15, wherein the virtualization server is further configured to:
send, based on identifying that the data quantity meets or exceeds the data volume threshold, the driver provision information.

17. The computing system of claim 15, wherein the virtualization server is further configured to:
based on identifying that the data quantity is less than the data volume threshold:
transmit the native query to the data source,
receive, from the data source, the data source results, and
transmit, to the client device, the data source results.

18. The computing system of claim 12, wherein the data virtualization query comprises a query for a single data source of the data source.

19. The computing system of claim 12, wherein the memory stores additional computer executable instructions that, when executed by the one or more processors, cause the computing system to:
cache, using the data virtualization driver, the native version of the data virtualization query.

20. One or more non-transitory computer-readable media storing instructions that, when executed by a computing system comprising at least one processor, a communication interface, and memory, cause the computing system to:
transmit, by a client device and to a virtualization server, a data virtualization query directed to a data source;
receive, by the client device and from the virtualization server, driver provision information comprising data source connection information for the data source and a native version of the data virtualization query;
provision, at the client device and using the driver provision information, a data virtualization driver corresponding to the data source, wherein the data virtualization driver is configured to bypass the virtualization server for direct data retrieval from the data source;
transmit, to the data source and using the data virtualization driver, the native version of the data virtualization query;
receive, from the data source, data source results; and
display the data source results.
